(19) United States
(12) Patent Application Publication
(10) Pub. No.: US 2005/0224541 A1
(43) Pub. Date: Oct. 13, 2005

(54) Apparatus and method for containing and transporting articles

(76) Inventors: Mark L. Campbell, Phoenix, AZ (US); Wade Gibbons, Scottsdale, AZ (US)

Correspondence Address: Douglas W. Gilmore;NOBLITT & GILMORE, LLC, Suite 6000, 4800 N. Scottsdale Road, Scottsdale, AZ, 85251, US

(21) Appl. No.: 10/812,772

(22) Filed: Mar. 30, 2004

(51) Int. Cl. G21C 9/00; B60R 7/00

(52) U.S. Cl. 224/282

(57) ABSTRACT

An exemplary apparatus and method for the containment and transportation of articles is disclosed as comprising inter alia a container (100) having a lid (120) and a receiving portion (110), where the lid (120) engages the receiving portion (110) to form an interiorly disposed containment volume. The container (100) may be secured and moveably attached to a mounting surface (210) with a releasable locking hinge (160) such that the container (100) may be positioned in various orientations. Disclosed features and specifications may be variously controlled, adapted or otherwise optionally modified to improve the security and convenience of containment or transportation for any application or operating environment. Exemplary embodiments of the present invention generally provide for the secure containment and transportation of construction and diagnostic field equipment, such as nuclear ground density gauges for example.

### FIELD OF INVENTION

The present invention generally concerns devices and methods for the substantially secure containment and transportation of articles; and more particularly, in various representative and exemplary embodiments, to containment and transportation of construction and/or diagnostic field equipment, such as nuclear ground density gauges.

### BACKGROUND

Technological advances in equipment used for modern construction have produced tools that are more susceptible to damage and have relatively high replacement costs. Additionally, the possession, transfer and maintenance of some of these tools may be regulated or otherwise monitored by government agencies. For example, nuclear ground density gauges have sensitive electronic components, may cost anywhere from $5,000 to $20,000, and their use in the United States is regulated by the Nuclear Regulatory Commission (NRC).

If a nuclear gauge becomes damaged during transport, it may need to undergo costly repairs or replacement. Alternatively, if a nuclear gauge is lost or stolen, in addition to requiring costly replacement, the owner may be fined for failing to comply with State and/or Federal regulations.

Departments of Transportation in several States have recently adopted standardized policies for securing nuclear gauges during transport. In accordance with the following requirements, nuclear gauges must be secured with at least two locks: (1) the gauge handle and case must be locked; (2) the exterior container surrounding the gauge case must be locked; and (3) the exterior container must be secured to the transport vehicle so that movement forward, backward, or side-to-side is no more than a quarter of an inch.

Conventional devices and methods for the transportation of nuclear ground density gauges have been inadequate; resulting in costly losses due inter alia to damage in transport, loss and/or theft. Accordingly, there exists a need to prevent, obstruct, deter or otherwise avoid damage, loss and/or theft of nuclear gauge devices. That notwithstanding, the same need to avoid damage, loss and/or theft extends more generally to any article that may be susceptible to relatively high replacement cost.

### SUMMARY OF THE INVENTION

In various representative aspects, the present invention provides an apparatus and method for the containment and transportation of articles.

Exemplary features are generally disclosed as including a container having a lid portion and a receiving portion, where the lid portion is configured to engage the receiving portion to form an interiorly disposed containment volume. Exemplary features further provide a container that may be moveably and securely attached to a surface with a releasable locking hinge, wherein engagement of the container with the surface allows the container to be positioned in various orientations.

Additional advantages of the present invention will be set forth in the Detailed Description which follows and may be obvious from the Detailed Description or may be learned by practice of exemplary embodiments of the invention.

Still other advantages of the invention may be realized by means of any of the instrumentalities, methods or combinations particularly pointed out in the claims.

### BRIEF DESCRIPTION OF THE DRAWINGS

Representative elements, operational features, applications and/or advantages of the present invention reside inter alia in the details of construction and operation as more fully hereafter depicted, described and claimed—reference being made to the accompanying drawings forming a part hereof, wherein like numerals refer to like parts throughout. Other elements, operational features, applications and/or advantages will become apparent to skilled artisans in light of certain exemplary embodiments recited in the Detailed Description, wherein:

FIG. 1 representatively illustrates a three-quarter, isometric view of a device in accordance with an exemplary embodiment of the present invention; and

FIG. 2 representatively illustrates a side view of the device generally depicted in FIG. 1 in accordance with another exemplary embodiment of the present invention.

Those skilled in the art will appreciate that elements in the Figures are illustrated for simplicity and clarity and have not necessarily been drawn to scale. For example, the dimensions of some of the elements in the Figures may be exaggerated relative to other elements to help improve understanding of various embodiments of the present invention. Furthermore, the terms ‘first’, ‘second’, and the like herein, if any, are generally used for distinguishing between similar elements and not necessarily for describing a sequential or chronological order. Moreover, the terms ‘front’, ‘back’, ‘top’, ‘bottom’, ‘over’, ‘under’, and the like, if any, are generally employed for descriptive purposes and not necessarily for comprehensively describing exclusive relative position or order. Skilled artisans will therefore understand that any of the preceding terms so used may be interchanged under appropriate circumstances such that various embodiments of the invention described herein, for example, are capable of operation in other orientations and environments than those explicitly illustrated or otherwise described.

### DETAILED DESCRIPTION OF EXEMPLARY EMBODIMENTS

The following descriptions are of exemplary embodiments of the invention and the inventors' conception of the best mode and are not intended to limit the scope, applicability or configuration of the invention in any way. Rather, the following Description is intended to provide convenient illustrations for implementing various embodiments of the invention. As will become apparent, changes may be made in the function and/or arrangement of any of the elements described in the disclosed exemplary embodiments without departing from the spirit and scope of the invention.

A detailed description of an exemplary application, namely an apparatus and method for the substantially secure containment and transportation of nuclear ground density gauges, is provided as a specific enabling disclosure that may be readily generalized by skilled artisans to any application of the disclosed apparatus and method for the containment and transportation of other articles.

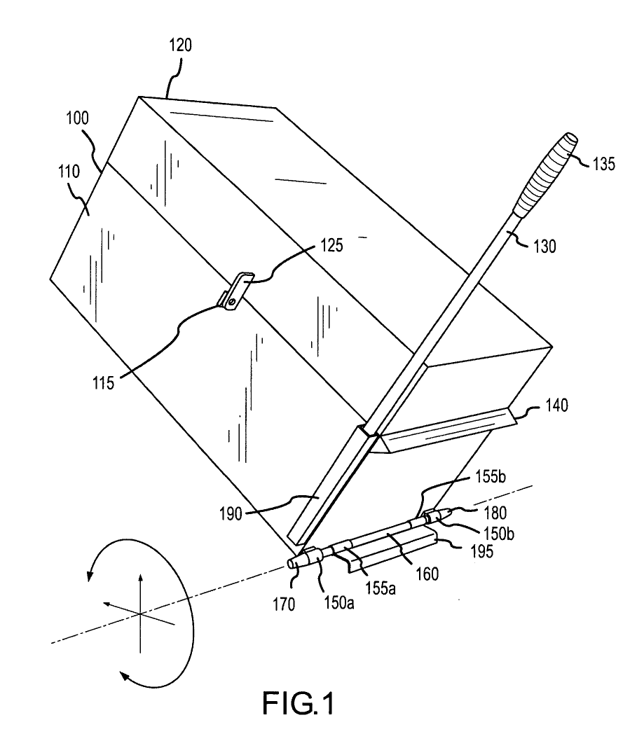

In accordance with an exemplary and representative embodiment of the present invention, FIG. 1 depicts a container device 100 suitably adapted for containment and/or transportation of, for example, nuclear ground density gauges. Container 100 comprises a upper lid portion 120 and a lower receiving portion 110. Upon engagement of lid 120 with receiving portion 110, a containment volume is generally defined therein.

Container 100 may provide a rectangular containment volume, as generally depicted for example in FIG. 1. Alternatively, conjunctively and/or sequentially, the containment volume may be configured to comprise any geometry, such as that of: a cube, a cylinder, a cone, a conic section, a sphere, etc. Additionally, the interiorly disposed containment volume may be molded or otherwise at least partially form-fitted for receiving articles of particular sizes and/or shapes therein. For example, in the case of a nuclear ground density gauge, the interior containment volume may be adapted to receive, isolate and/or otherwise contain discrete gauge parts or components. Alternatively, the containment volume may be suitably adapted for receiving a substantially unitary carrying case that houses a device such as, for example, a ground density gauge.

Lid portion 120 and receiving portion 110 may be configured with locking features (125 and 115 respectively) such that engagement of lid portion 120 with receiving portion 110 provides, for example, a through-hole for receiving a pad-lock to secure lid portion 120 to receiving portion 110 so as to prevent, deter or otherwise obstruct unauthorized access to the interiorly disposed containment volume therein. Skilled artisans will appreciate that a variety of locking and/or secure engagement mechanisms may be employed in order to obtain a substantially similar result. For example, any combination of the following elements may be alternatively, conjunctively and/or sequentially employed: a hinge, a flap, a hasp, a lock, a pin, a bolt, a rod, a dowel, a press fitting, a clip, a clasp, a hook, a button, a clamp, a tab, a clench, a grapple, a grip, a cam-lock, a bearing-lock, a knob, a knurled nut, a quick-release, and/or the like in addition to any engagement mechanisms whether now know or otherwise hereafter described in the art. Although not expressly represented in the Figures, lid portion 120 and receiving portion 110 may be pivotally engaged, for example, with a hinge such that lid portion 120 and receiving portion 110 may be brought into relative position to provide for substantially secure subsequent engagement.

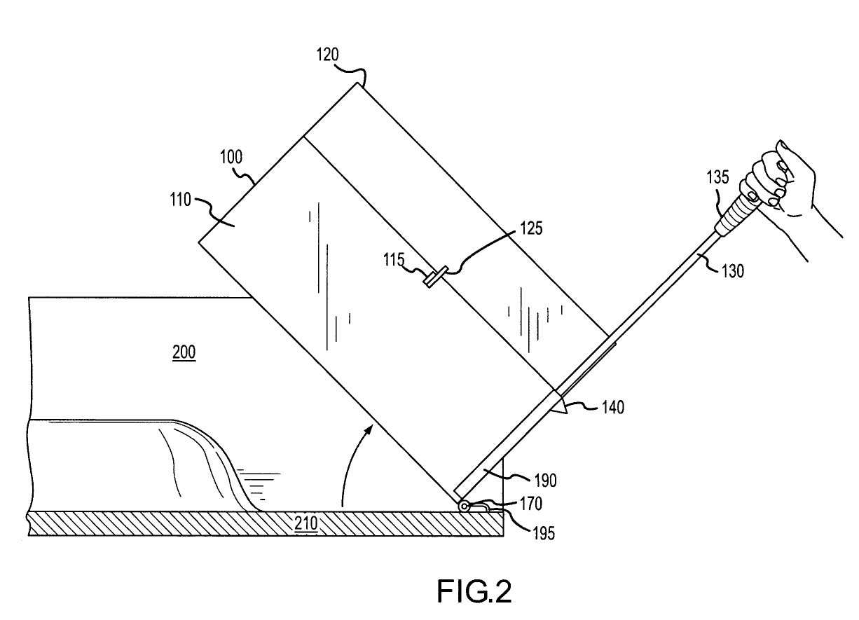

Container 100 may be configured with a releasable locking hinge bolt 160 for secure engagement with a storage and/or transport surface. In an exemplary embodiment, container 100 may be mounted to the bed 210 of a truck 200, as generally depicted, for example, in FIG. 2. Container 100 may comprise engagement hinges 150a, 150b that mate with surface hinges 155a, 155b of hinge plate 195 so as to receive locking hinge bolt 160 therethrough. After locking hinge bolt 160 is fitted with hinge cap 170 and hinge lock 180, container 100 is secured to surface 210.

In general, engagement of container 100 with surface 210 permits container 100 to be positioned in at least a first orientation and a second orientation. As representatively depicted in FIG. 2 for example, container may be rested on surface 210 or pivoted substantially 90 degrees from the resting position in order to allow access to the containment volume in a substantially vertical orientation. Skilled artisans will appreciate that a variety of other orientations may be selected to achieve a particular purpose.

Container 100 may also be optionally configured with a pull-rod receiving portion 190 and a pull-rod 130 to allow convenient positioning of container 100 in various orientations. Pull-rod 130 may also comprise a handgrip 135 or such other features that might tend to render pull-rod 130 more ergonomically adapted for a particular application and/or operating environment. An additional feature of pull-rod 130 is the ability to employ a mechanical advantage for moving heavy equipment; thereby avoiding, for example, potential workers compensation claims.

Container 100 may also comprise a stand-off feature 140, such as the corrugation or rail 140 generally depicted in FIG. 1, in order to promote inter alia stability while container 100 is positioned in a particular orientation. Skilled artisans will appreciate that a variety of stand-off components may be alternatively, conjunctively and/or sequentially employed, such as, for example: a leg, a peg, a nub, a corrugation, a finger, a post, a rail, a pad, a cushion, a spring, a shock absorbing element, and/or the like, in order to produce a substantially similar result.

Container 100 may be fabricated from any material now known or otherwise hereafter described in the art. In a representative embodiment, container 100 may comprise 16 gauge, diamond-plate aluminum. Diamond-plating may serve to ‘camouflage’ container 100 so that it is mistaken for a toolbox or an integrated vehicle compartment, for example. In other exemplary embodiments, diamond-plating and/or various other patterns, colors, etc. may be employed for aesthetic considerations and/or to association container 100 with a particular brand or intended use. Other gauges of aluminum, steel and/or the like may be used to manufacture container 100; however, in the event that container 100 is designed for containment or transportation of nuclear gauges, NRC regulations governing materials and thicknesses should be followed. For example, in the case of aluminum diamond-plate, the NRC requires sixteen (16) gauge as a minimum thickness. Skilled artisans will also appreciate that releasable locking hinge bolt 160 should be manufactured from a high strength material (such as high tensile steel and/or the like); a variety of materials may be alternatively, conjunctively and/or sequentially employed to achieve a hinge bolt 160 capable of securing the mass of container 100.

The exemplary embodiments of the present invention generally depicted in FIG. I and FIG. 2 presume that container 100 may be positioned in at least two orientations. No such limit, however, should be presumed for other embodiments of the invention. For example, container 100 may be adapted for positioning in three or more orientations. Alternatively, container 100 may be adapted to provide a single orientation for both loading and unloading, and/or storage and transportation. That is to say that in the appended claims, where at least two positional orientations of container 100 may be indicated, a first orientation may be identical or substantially equivalent to a second orientation. Indeed, in such a case where the first orientation is substantially equivalent to the second orientation, carrier 100 may be substantially immobile (translationally, rotationally, etc.) with respect to a mounting surface.

In the foregoing specification, the invention has been described with reference to specific exemplary embodiments; however, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above. For example, the steps recited in any method or process claims may be executed in any order and are not limited to the specific order presented in the claims. Additionally, the components and/or elements recited in any device claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components of any or all the claims.

As used herein, the terms ‘comprises’, ‘comprising’, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted by those skilled in the art to specific environments, manufacturing specifications, design parameters or other operating requirements without departing from the general principles of the same.

1. A device for securely transporting at least one article therein, said device comprising:
a container;
said container comprising at least one lid portion and at least one receiving portion, wherein said lid portion is suitably adapted to engage said receiving portion to form at least one containment volume therein;
said container suitably adapted for substantially secure engagement with a surface, wherein said engagement of said container with said surface permits the container to be positioned in at least a first orientation and a second orientation.

2. The device of claim 1, wherein said container further comprises a pull-rod receiving portion suitably adapted to receive a pull-rod for moving the container from a position in a first orientation to a position in a second orientation.

3. The device of claim 2, wherein said second orientation is approximately 90 degrees displaced from said first orientation.

4. The device of claim 1, wherein said engagement of said lid portion with said receiving portion comprises at least one of a hinge, a flap, a hasp, a lock, a pin, a bolt, a rod, a dowel, a press fitting, a clip, a clasp, a hook, a button, a clamp, a tab, a clench, a grapple, a grip, and a quick-release.

5. The device of claim 1, wherein said containment volume is at least one of substantially unitary and conformationally molded to receive an article for containment therein.

6. The device of claim 1, wherein at least one of said lid portion and said receiving portion further comprises at least one stand-off feature for at least one of positioning and resting said container in a particular orientation.

7. The device of claim 6, wherein said stand-off feature comprises at least one of a leg, a peg, a nub, a corrugation, a finger, a post, a rail, a pad, a cushion, a spring, and a shock absorbing element.

8. The device of claim 1, further comprising a surface for resting said container thereon, said surface comprising at least one stand-off feature for at least one of positioning and resting said container in a particular orientation.

9. The device of claim 8, wherein said stand-off feature comprises at least one of a leg, a peg, a nub, a corrugation, a finger, a post, a rail, a pad, a cushion, a spring, and a shock absorbing element.

10. The device of claim 1, wherein said engagement of said container with said surface comprises at least one of a hinge, a flap, a hasp, a lock, a pin, a bolt, a rod, a dowel, a press fitting, a clip, a clasp, a hook, a button, a clamp, a tab, a clench, a grapple, a grip, a cam-lock, a bearing-lock, a knob, a knurled nut, and a quick-release.

11. The device of claim 1, wherein said surface comprises the bed of a truck, the trunk of a car, the roof of a vehicle, the frame of a vehicle, the chassis of a vehicle, and a trailer bed.

12. The device of claim 1, wherein said first orientation and said second orientation comprise at least one of a transporting position, an operating position, a stowed position, a loading position, and an unloading position.

13. A method for securely transporting articles, said method comprising the step of:
providing a container;
said container comprising at least one lid portion and at least one receiving portion wherein said lid portion is suitably adapted to engage said receiving portion in order to form at least one containment volume therein;
said container suitably adapted for substantially secure engagement with a surface, wherein said engagement of said container with said surface permits the container to be positioned in at least a first orientation and a second orientation.

14. The method of claim 13, further comprising the step of employing a pull-rod for moving said container from a position in said first orientation to a position in said second orientation.

15. The method of claim 13, further comprising the step of engaging said lid portion with said receiving portion with at least one of a hinge, a flap, a hasp, a lock, a pin, a bolt, a rod, a dowel, a press fitting, a clip, a clasp, a hook, a button, a clamp, a tab, a clench, a grapple, a grip, and a quick-release.

16. The method of claim 13, further comprising the step of at least one of positioning and resting said container in a particular orientation with respect to a surface.

17. The method of claim 13, further comprising the step of at least one of:
loading an article into said containment volume;
unloading an article from said containment volume;
transporting an article in said containment volume;
transporting the container;
securing an article within said containment volume;
detaching the container from engagement with said surface;
disposing the container to a position substantially removed from said surface; and
operating a device substantially within said containment volume.

18. The method of claim 13, further comprising the step of engaging said container with said surface with at least one of a hinge, a flap, a hasp, a lock, a pin, a bolt, a rod, a dowel, a press fitting, a clip, a clasp, a hook, a button, a clamp, a tab, a clench, a grapple, a grip, a cam-lock, a bearing-lock, a knob, a knurled nut, and a quick-release.

19. A container apparatus for securely transporting a nuclear gauge device, said container comprising:
a lid portion and a receiving portion, wherein said lid portion is suitably adapted to engage said receiving portion in order to form a containment volume therein;
said containment volume suitably adapted to receive a nuclear gauge device for containment therein;
said engagement of said lid portion with said receiving portion comprising at least one of a hinge and a lock;
said container apparatus suitably adapted for substantially secure engagement with a surface, wherein said engagement of said container apparatus with said surface permits the container apparatus to be positioned in a first orientation approximately 90 degrees displaced from a second orientation; and
said engagement of said container apparatus with said surface comprising at least one of a hinge, a lock, a bearing-lock, a knurled nut, and a quick-release.

20. The container apparatus of claim 19, wherein said first orientation and said second orientation comprise at least one of a transporting position, an operating position, a stowed position, a loading position, and an unloading position.
